(19) United States
(12) Patent Application Publication
(10) Pub. No.: US 2026/0062969 A1
(43) Pub. Date: Mar. 5, 2026

(54) MULTI-POINT LOCKING DEVICE FOR WINDOWS OR DOORS

(71) Applicant: Fapim S.p.A., Altopascio (LU) (IT)

(72) Inventor: Sergio Pacini, Montecarlo (LU) (IT)

(21) Appl. No.: 19/108,183

(22) PCT Filed: Aug. 31, 2023
(86) PCT No.: PCT/IB2023/058618

§ 371 Date: Mar. 3, 2025

(30) Foreign Application Priority Data
Sep. 2, 2022 (IT) 102022000018027

(51) Int. Cl. E05C 9/02; E05B 1/00; E05B 17/20

(52) U.S. Cl. CPC E05C 9/02; E05B 1/003; E05B 17/2038

(57) ABSTRACT

Locking device comprising a central body (1) and a handle (2) with movement means (4) which engage a rod (3). Handle is rotatable between an open position and a closed position. In the closed position, FIG. 1 effective anti-effraction means are provided to block movement of the rod. Therefore, movement means (4) comprise a rotor (41) and a single protuberance (42) which engages a seat (312) of a mobile element (31) of the rod (3); Rotation of the handle to the closed position leads to blocking of the mobile element (31) by interaction an edge of the seat (312a) with a head (421) of the protuberance. Thereby, a locking device for windows or doors, such as sliding doors and windows, with burglary-resistant characteristics is provided.

The present invention relates to a locking device for windows or doors, such as sliding doors and windows, with burglary-resistant characteristics.

There is a need in the market to make windows or doors which are increasingly secure and therefore have burglar-resistant characteristics. To meet this requirement, window or door solutions exist which install closure/locking systems which cannot be operated from the outside, e.g., by acting directly on the movable rod of the movable frame or on the closure pins, but only by rotating the handle.

A solution of this type is described in the French patent FR2861116. In this example, the closure system of the movable frame on the fixed frame consists of a vertically sliding rod and a central body which rotatably installs the handle. The rod supports movable pins which engage respective housings integral with the fixed frame to determine the stable closure of the window or door. The handle is in turn connected to a toothed element rotatably housed inside the central body. Rotating the handle causes the toothed element to rotate. The latter mates with a rack supported by the movable rod; as a result of this mating, the rotation of the toothed element causes the translation of the rod in the vertical direction, when opening or closing the movable frame with respect to the fixed frame. The toothed element provides a plurality of teeth and the rack an adequate length to cover the entire due movement of the rod. The last of the teeth of the toothed element is capable, following a final rotation movement of the handle, of engaging with the relative toothing of the rack, thus causing an impediment to the vertical sliding of the rod. Only the release of the handle, thus its rotation in the opposite direction, allows the tooth and rack to free themselves from the engagement and regain the proper mating.

With this system it is therefore impossible to open the movable frame by acting directly on the rod or the pins.

However, this type of solution and similar solutions have a number of drawbacks.

In particular, jamming due to poor mating between the toothed element and the rack is very common.

It is also a constructively complex and therefore expensive system.

The known system is also bulky.

There is thus a search for solutions which are secure against burglary but at the same time solve the problems outlined above.

In particular, the object of the locking device according to the invention is to be constructively simple as well as space-saving.

Further, the locking device aims to be reliable and hardly subject to jamming.

A further object of the locking device is to serve as an alternative to known systems.

The characteristics and advantages of the locking device according to the present invention will become clearer from the following description of an embodiment thereof, given by way of a non-limiting example with reference to the appended drawings in which:

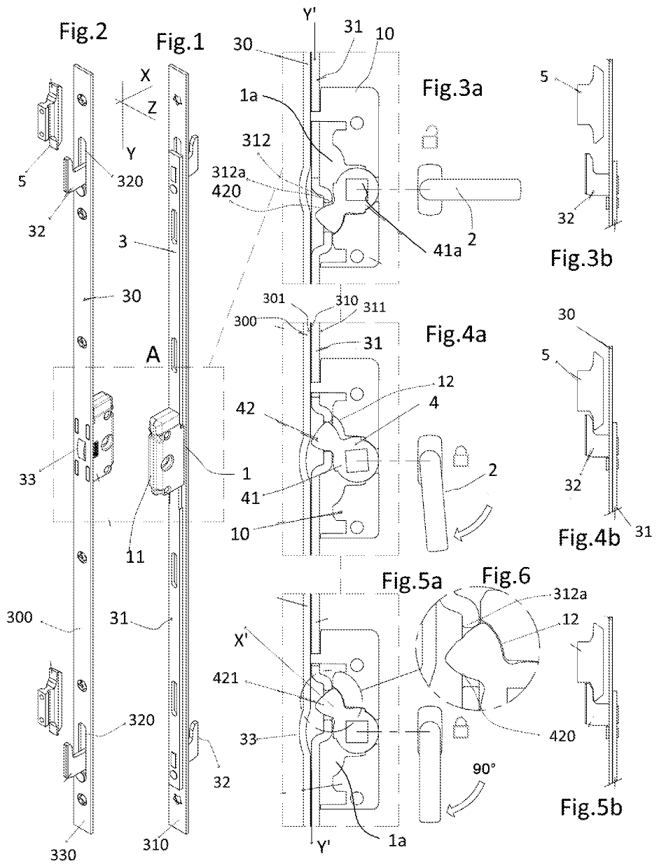

FIG. 1 is a first view of the locking device as a whole, intended to be mounted on a movable frame of a window or door (not shown);

FIG. 2 is a second view of the locking device in which housings are also shown, of the fixed frame, for closure pins supported by a movable rod of the locking device;

FIG. 3a is an enlargement of part A indicated in FIG. 1, in which only a central body of the device is shown in schematic form, with some parts omitted for the interpretative clarity of the drawing and to allow the movement means contained in the central body to be shown; a section of a rod of the device working at the central body is also visible in the figure; a handle is then symbolically depicted, in the zero rotation position of the handle, i.e., open movable frame of the window or door;

FIGS. 4a and 5a show successive rotation steps of the handle and consequently of the movement means and of the rod, where FIG. 4a represents the rotation point of angle α of the handle, i.e., the closed position of the movable frame of the window or door, and where FIG. 5a represents the maximum rotation point of the handle, i.e., locking of the movable frame;

FIGS. 3b, 4b, 5b represent the movement of movable pins supported on the rod, with respect to respective housings mounted on the fixed frame of the window or door;

FIG. 6 shows an enlargement of a protuberance of the movement means of the device in the maximum handle rotation position, i.e., with the movable frame locked.

With reference to said figures, the locking device described below is mounted on the frame of a movable frame of a window or door (not shown). Such a movable frame defines a vertical axis Y, which is that of the vertical development of the window or door itself, and is usually perpendicular to the ground during assembly. The horizontal axis X is defined as perpendicular to the vertical axis Y and coplanar to the window or door itself. The window or door therefore lies on the plane XY. The Cartesian triad also consists of a transverse axis Z which is perpendicular to the vertical axis Y and to the horizontal axis X and is the axis of rotation of the handle, as will become clear below.

Given these spatial references, the locking device will now be described. It comprises a central body 1 on which a handle 2 is installed, which controls the opening or closing of the device itself.

The central body 1 is box-shaped and defines at least a first face 10 on the plane XY, on which the handle 2 rotatably lies, and at least a second face 11 on the plane YZ, perpendicular to said first face.

The central body 1 is connected to a rod 3 of the locking device which develops linearly according to its own main development axis Y′ and, in assembly, according to the vertical axis Y.

The connection between central body 1 and rod 3 materialises at such a second planar face 11.

Going into greater detail, the rod 3 consists of two mutually overlapping components, one fixed 30 and one movable 31, sliding along its main development axis Y′ along the fixed component 30 of the rod.

The movable component 31 of the rod is slidingly engaged with respect to the second planar face 11.

The fixed component 30 of the rod is instead stably engaged to the panel and to the central body 1.

For the sake of simplicity, in the remainder of the description, the movable component 31 of the rod 3 will be referred to as movable rod 31, while the fixed component 30 of the rod 3 will be referred to as fixed rod 30.

In a preferred embodiment variant, illustrated in the figures, the fixed rod 30 and the movable rod 31 are flat, thus each defining two opposite flat faces, 300, 301 and 310, 311 respectively. The two rod components are thus mounted superimposed with two flat faces 301, 310 in contact and the sliding of the movable rod on the fixed rod occurs by sliding one face 310 on the other 301.

The central body 1 defines a seat 1a within which the linear movement means 4 of the movable rod 31 are contained. The seat 1a faces the face 11 of the main body.

In detail, such means comprise a rotor 41 rotatably housed inside the seat 1a. The rotor 41 has a housing 41a within which the handle 2 is engaged. The handle, and consequently the rotor 41 are rotatable around the axis Z.

The rotation of the handle is comprised between a minimum angle α and a maximum angle β, considered on the axis X, where at minimum rotation the handle is aligned with the axis X and the movable frame is open (FIG. 3a), while at maximum rotation the handle is aligned with the axis Y (perpendicular to the axis X) and the movable frame is locked (FIG. 5a). In a preferred solution, the minimum rotation corresponds to the angle α=0°, while the maximum rotation corresponds to the angle β=90°.

The rotor 41 supports a single protuberance 42 which projects therefrom perpendicular to the axis Z of rotation, extending on the plane XY, according to its own main development axis X′. The protuberance engages with the movable rod 31. In more detail, the protuberance 42 engages within a seat 312 made on the movable rod 31. The seat 312 has respective edges 312a defined on the axis X and in general on an axis perpendicular to the linear development axis of the rod Y′.

As a result of such an engagement, the rotation of the protuberance 42 around the axis Z commands the translation of the movable rod 31 according to the axis Z.

Evidently, the handle can be rotated clockwise or counter-clockwise causing the window or door to open or close (and vice versa), therefore the movable rod 31 can translate along the axis Z in either linear direction.

The protuberance 42 has at least two opposite and symmetrical sides 420 with respect to the axis of its own development X′. During the rotational movement of the handle from the open position of the movable frame to the closed position of the movable frame, an intermediate position I of angle γ, comprised between the minimum rotation angle and the maximum rotation angle of the handle, i.e., α<γ<β, corresponding to a closed position of the movable frame, is identified (FIG. 4a). In the preferred solution 0°<γ<90°. In an embodiment variant γ=80°.

During the rotational movement of the rotor, the edge 312a of the seat 312 of the movable rod 31 facing the respective side 420 of the protuberance 42 makes contact therewith, sliding, and this sliding movement corresponds to the translation of the movable rod 31 on the axis Y.

Obviously, such movement will be carried out in a similar manner on the opposite side and edge to obtain translation in the opposite direction along the axis Y.

When the handle reaches the intermediate portion I, the edge 312a reaches the end of the side 420. In such a position, the window or door is closed, i.e., the movable frame is closed with respect to the fixed frame (FIG. 4a).

A head 421 of the protuberance 42 extends between the two sides 420, straddling the axis thereof X′.

In the final segment of the handle rotation, which goes from γ to 90°, the edge 312a of the seat 312 straddles the side 420 until it abuts with such a head 421. Such an abutment prevents the further sliding of the movable rod 31 along the axis Y, constituting a mechanical constraint to the translation (FIG. 5a and FIG. 6).

Therefore, in this limit switch position of the handle 2, the movable rod 31 is prevented from sliding linearly. The advantage is obtained that by acting directly on the movable rod, the handle cannot be rotated, obtaining an anti-burglary effect.

The limit switch for the rotation of the rotor 41, corresponding to both the open position of the movable frame (rotation of angle α) and the closed position of the movable frame (rotation of angle β), is materialised by respective shaped faces 12 of the seat 1a of the central body 1, symmetrically arranged with respect to the axis X; the respective side 420 of the protuberance in one of the two handle rotation end positions abuts against such a shaped face (FIGS. 3a and 5a).

Further, the movable rod 31 installs hooks or pins 32 at its terminal ends. The pins project from the face 310 of the movable rod, e.g., along the axis X. Suitable slots 320 on the fixed rod 30 allow each pin to pass through it and project from the face 300, that is, the one which in assembly faces the fixed frame. The slots 320 elongate along the axis Y′ by an adequate amount to receive the entire translation of the pins 32 corresponding to the rotation from a to B.

There are housings 5 on the fixed frame (not shown) on which the movable pins engage to obtain the closing and locking of the movable frame. FIGS. 3b, 4b and 5b represent the mutual engagement between housings and movable pins as a function of the handle rotation positions.

In particular, in the rotation arc from a to y the pins do not engage with the housings, therefore the movable frame is open; in the rotation arc from y to ß the pins engage with the housings, therefore the movable frame is closed. The locking is obtained when, together with the engagement of the pins with the respective housings, the head of the protuberance also abuts the edge 321a.

Consider now the fixed component 30 of the rod 3. It has a recess 33 at the central body 1, and in particular at the seat 1a of the central body. The recess is in the form of a shape of the fixed rod which defines a recess adapted to receive the rotation of the protuberance 42. Such a recess 33 results in a corresponding protrusion on the face 300 of the fixed component of the rod.

The device described has a series of advantages.

Thanks to the fact that there is no mating between a gear and a rack, the movement is smoother and less subject to jamming.

The system is also constructively simple and therefore more reliable.

Thanks to the fact that the fixed rod has a recess for receiving the head of the protuberance in rotation, and the absence of a rack on the rod, the device is also extremely compact.

These advantages are combined with an effective anti-burglary action.

The present invention has been described hereto with reference to preferred embodiments thereof. It is intended that other embodiments may exist which relate to the same inventive core, all falling within the scope of protection of the claims indicated below.

1. A locking device for a window or door, adapted to be arranged on a movable frame of said window or door, said device comprising:
a central body;
a handle engaging rotatably according to an axis of rotation on said central body, where said handle is rotatable between a minimum angle α and a maximum angle β of rotation around the axis, where the rotation of angle α corresponds to an open position of said movable frame, while the rotation of angle β corresponds to the locked position of said movable frame, the handle also assuming an intermediate rotation position I of angle γ where α<γ<β, said intermediate position I corresponding to a closed position of said movable frame;
a rod extending according to a main development direction perpendicular to said axis of rotation, said rod being slidingly connected to said central body;
movement means of said rod housed in said central body in a rotatable arrangement with respect to the rotation axis, said linear movement means engaging with said handle and said rod;
hooks supported by said rod and adapted to engage/disengage with respective seats of a fixed frame of the door or window due to the translation of said rod, in order to close/open the movable frame with respect to said fixed frame;
said device being characterized in that:
said rod comprises two rod-shaped elements, one of which is fixed with the central body and a second is mobile sliding on the fixed-one rod-shaped element and with respect to the central body, said mobile element of the rod installing said hooks;
said movement means comprise a rotor rotatable with respect to the axis and connected to said handle , a single protuberance projecting by said rotor in a direction, perpendicular to the axis of rotation and to the development axis, said protuberance engages with a seat of said mobile element of the rod;
said protuberance defining two sides symmetrical with respect to the axis and a head arranged between the two sides and straddling the axis, said seat defining two edges each facing towards one of the respective sides;
in which said side abuts against said respective edge up to the point of intermediate position I of the handle , while for the further rotation segment from the intermediate position I to the angle position β said side abuts against said head;
as a result of this abutment, the movable element of the rod is prevented by the translation according to said development axis.

2. The device according to claim 1 in which said movement means are housed within a seat of said central body, said seat opening onto a face of said body.

3. The device according to claim 1 in which each edge is defined on an axis perpendicular to the axis of development of the rod.

4. The device according to claim 2, wherein said fixed element of said rod provides a recess which opens towards said seat and such as to receive said head of said protuberance during its rotational movement.

5. The device according to claim 4 wherein said seat comprises two shaped faces symmetrically arranged with respect to an axis perpendicular to the axis of rotation of the handle, where each shaped face defines an abutment surface for one respective of said side of the protuberance in the end positions of rotation of the handle, corresponding to the rotation angles α and β.

6. The device according to claim 5 in which said fixed element of the rod provides slots elongated according to the axis suitable for being crossed by said hooks.

7. The device according to claim 1 in which α=0°.

8. The device according to claim 1 in which β=90°.

9. The device according to claim 1 in which γ=80°.

10. The device according to claim 1 in which in said position equal to α=0° up to said intermediate position said hooks not engage with said seats, while in any position included between angles γ and β said hooks engage with said seats.
